(19) United States
(12) Patent Application Publication
(10) Pub. No.: US 2005/0191403 A1
(43) Pub. Date: Sep. 1, 2005

(54) Palliative treatment for gluten intolerance

(75) Inventors: Teodor Stelmasiak, Maribyrnong (AU); Hugh James Beatty Cornell, Templestowe (AU)

Correspondence Address: LADAS & PARRY, 26 WEST 61ST STREET, NEW YORK, NY, 10023, US

(73) Assignee: GLUTAGEN PTY LTD

(21) Appl. No.: 10/996,081

(22) Filed: Nov. 22, 2004

Related U.S. Application Data
(63) Continuation of application No. PCT/AU03/00633, filed on May 23, 2003.

(30) Foreign Application Priority Data
May 23, 2002 (AU) PS2523

(51) Int. Cl. A23L 1/10

(52) U.S. Cl. 426/641

(57) ABSTRACT

Use of one or more peptidase enzymes in the manufacture of a medicament for treatment of gluten intolerance, wherein one or more peptidase enzymes are capable of enzymatic digestion of gluten peptide residues.

The present invention relates to a pharmaceutical or nutraceutical formulation for treating gluten intolerance. The invention includes a method of isolating active ingredients, the preparation of a pharmaceutical or nutraceutical formulation and a method of treatment using such formulations.

Gluten is a mixture of proteins, predominantly prolamins (gliadins) and glutelins. It is derived from grains, particularly wheat, barley, rye and oats; and is used widely in the food industry in products such as cakes and breads which are made from grains. Gliadins, derived from wheat flour, can be classified into several groups, including α-type, γ-type and ω-type. Different gliadins are present in each subcultivar of wheat, with variations in the amino acid sequences within each type. Gliadins are characterized by a molecular mass of around 40 kDalton, insolubility in neutral aqueous solutions and an N-terminal domain rich in glutamine and proline.

A condition exists, predominantly in areas where wheat is a major food source, (Europe, North America, Australia), which results in gluten intolerance. In these areas, the incidence of the disease is about 1 per 300 head of population. The symptoms of this condition include abdominal pain, bloating and diarrhoea. In severe cases, known as coeliac disease, there are inflammatory changes to the intestinal mucosa, resulting in malabsorption of nutrients. This in turn may lead to anaemia, increased tendency to haemorrhage and an increased risk of gastrointestinal tumours.

The pathogenesis of ceoliac disease appears to have both genetic and environmental factors. Whilst genetic predisposition is a major factor, (about 10% of first degree relatives are affected), the fact that monozygotic twins have a concordance rate of only about 75% suggests that environment also plays a part.

Coeliac disease patients characteristically have T cells present in the intestinal mucosa which recognize the toxic sequences of gliadins. Evidence suggests that these T cells play a crucial role in the immunopathogenesis of the disease. Proliferation of gliadin-specific HLA-DQ2-restricted T cell clones from the intestine of coeliac disease patients can be initiated in vitro by the addition of a water-soluble form of gliadin to HLA-DQ2 carrying antigen-presenting cells.

At present, the chief therapy for gluten intolerance is to impose a gluten-free diet on the patient. Due to the number of food products containing either cereals which contain gluten, or gluten per se, this constitutes a severe restriction to the food choices available to a patient.

It has been discovered that in gluten intolerant individuals, enzymes normally present in the small bowel that are necessary for the digestion of gluten are missing. Peptide fragments produced by incomplete digestion of grain protein are toxic to such individuals; the most toxic peptides being those derived from α-gliadin, or a similar protein called A-gliadin.

Serine-containing peptides, (containing PSQQ and possibly also QQQP motifs, as found in residues 11-19 of A-gliadin), appear to have a cytotoxic effect. Tyrosine-containing peptides, (containing QQPY and/or QPYP motifs, as found in residues 75-86 of A-gliadin), are associated with immunological activity and hence, toxicity.

Experiments indicate that active serine-containing peptides like 11-19 and active tyrosine-containing peptides like 75-86 are incompletely digested by mucosal enzymes in patients suffering from coeliac disease. The residual peptide sequences, such as 11-18 and 77-84, are still toxic, which suggests that the aetiology of coeliac disease is connected to defective mucosal digestion and that the pathogenesis of the disease results from the action of the undigested peptides on the mucosa. This may ultimately be due to deficiency in a single enzyme in coeliac disease patients, but at least two different types of peptide residues build up and cause damage to mucosal tissue.

The present invention provides a prophylactic treatment for gluten intolerance. The invention also provides a pharmaceutical or nutraceutical formulation for use in treating patients for gluten intolerance, and a method of making the formulation. Finally, the invention provides a method of extracting enzymes from animal mucosa, for use in a pharmaceutical or nutraceutical formulation for treatment of gluten intolerance.

In a first embodiment of the invention, an extract is obtained from animal intestinal mucosa. The extract contains one or more peptidase enzymes capable of digesting gluten peptide residues; in particular, certain serine-containing peptide residues and tyrosine-containing peptide residues. Most preferably, the peptidase enzymes are capable of digesting residues 11-19 and 75-86 of A-gliadin. The extract is obtained by collecting and chilling animal duodena. The duodena are preferably porcine, bovine or ovine; more preferably porcine. Intestinal digesta are removed from the chilled duodena, and the intestinal mucosa is separated from the duodena, preferably by scraping. The intestinal mucosa is then homogenized with an equal volume of deionized water to form an aqueous mixture, and clarified. Clarification may be by any suitable means, for example filtration or centrifugation. Preferably, clarification is by centrifugation for about one hour at about 1500 g, using one litre buckets in a Beckman laboratory centrifuge, or equivalent. The supernatant is collected and the precipitate is discarded. The supernatant is then concentrated by ultra filtration, preferably using a filtration membrane of about 100 kDaltons. The resulting concentrate is then freeze-dried to form a freeze-dried enzyme extract.

A further embodiment of the invention provides a pharmaceutical or a nutraceutical formulation one or more peptidase enzymes capable of digesting gluten peptide residues, particularly certain serine-containing and tyrosine-containing peptide residues. Most preferably, the peptidase enzymes are capable of digesting residues 11-19 and 75-86 of A-gliadin. Peptidase enzymes occur widely in nature, and may be derived from any suitable source. Possible sources include naturally occurring or genetically modified bacteria, and plant or animal tissue. The enzymes are preferably provided in the form of an enzyme extract obtained from animal intestinal mucosa. In one embodiment of the invention, the formulation consists of an enterically coated capsule containing sufficient freeze-dried enzyme extract from animal intestinal mucosa to enzymatically digest peptide residues from 2.5 g gluten. A powder is prepared from the freeze-dried enzyme extract, which is milled to size 200 mesh and blended with glidants. Preferably the glidants form 0.5 to 3.0% weight of the formulation and are selected from talc B.P. and/or magnesium stearate B.P. More preferably, the formulation contains 1% weight talc and 0.5% weight magnesium stearate as glidants. The resulting blend is loaded into hard gelatine capsules (Park-Davis size “0”), so that each capsule contains 400 mg of the blend. The gelatine capsules are then enterically coated with a polymer based on a polymethacrylate, sold under the trade name “Eudragit L30 D-55” by Röhm GmbH. The resulting capsule contains sufficient enzyme extract to digest peptide residues from 2.5 g gluten.

In another embodiment, the formulation consists of an enterically coated tablet. A preferred tablet comprises 1% weight talc B.P., 1% weight magnesium stearate B.P., 8% weight polyvinylpyrrolidone B.P., 60% weight freeze-dried enzyme extract, 10% weight sodium starch glycolate B.P. and 20% weight lactose B.P. The tablet is then enterically coated with “Eudragit L30 D-55” polymethacrylate, as described above.

In a preferred embodiment of the formulation, the freeze-dried enzyme extract is fractionated to obtain a fraction having a molecular weight ranging from 150 to 200 kDalton. This fraction is then used in the formulation, in place of the unfractionated enzyme extract. Fractionation is preferably achieved using a gel chromatography column. The column is preferably loaded with “Sephacryl S-300 HR”, obtained from Amersham Pharmacia Biotech, Inc. The 150-200 kDalton fraction is combined with excipients and formed into a tablet, which is then enterically coated, or combined with excipients and loaded into a capsule, which is enterically coated, as described above.

The invention further provides a method of treating a patient suffering from gluten intolerance, comprising administering a digestive supplement containing one or more peptidase enzymes capable of digesting gluten residues, particularly certain serine-containing and tyrosine-containing peptide residues. Most preferably, the peptidase enzymes are capable of digesting residues 11-19 and 75-86 of A-gliadin. The peptidase enzymes are preferably provided in the form of an enzyme extract obtained from animal intestinal mucosa. Preferably, sufficient extract to enable enzymatic digestion of residues from 2.5 g gluten is administered, but higher dosages may be administered. In practice, it is expected that patients will be able to adjust dosages to conform to their gluten intake. Preferably, the dosage form is that of an enterically coated capsule containing sufficient extract to enable enzymatic digestion of residues from 2.5 g gluten.

Experimental Results

The invention will now be further described with reference to specific experiments. These experiments are by way of example only, and do not represent limitations to the scope of the invention.

### EXAMPLE 1

A freeze-dried enzyme extract was obtained in accordance with the invention. The extract was then fractionated using a hydrophilic rigid allyl dextran/N,N′-methylene bisacrylamide matrix, with a fractionation range for globular proteins of 1×10⁴Mᵣ to 1.5×10⁶Mᵣ. (This corresponds to 10 to 1500 kDalton). A suitable product is sold under the trade name Sephacryl S-300 HR by Amersham Pharmacia Biotech, Inc. The freeze-dried enzyme extract (0.15 g) was dissolved in 3.0 ml of a buffer consisting of a mixture of ammonium bicarbonate (0.02 mol/L) and sodium chloride (0.04 mol/L) and added to a fractionation column (84 ml) loaded with Sephacryl S-300 HR. Buffer was then run through the fractionation column at a rate of 22 ml per hour and fractions of 6 ml collected after the first 24 ml. Fractions 1 to 11 were thus collected, the last fraction being just after the total volume of the column.

### EXAMPLE 2

Each fraction from Example 1 was freeze-dried, dissolved in 1 ml deionized water and tested for enzyme activity using a rat liver lysosomal assay (Cornell, H. J. & Townley, R. R. W., Clinica Chimica Acta (1973) 49, 181-188). This assay is based on the fact that a peptic-tryptic-pancreatic digest of wheat gliadin disrupts rat liver lysosomes, causing a reduction in optical density (at 400 nm) of a suspension of these organelles. This is evidence of a cytotoxic reaction by the peptides present in the digest. However, if the enzyme extract is pre-incubated with the toxic digest for two hours, the change in optical density is much less after incubation with the lysosomes. By comparing a control (no toxic digest), a toxic sample (lysosomes incubated with a toxic digest of gliadin) and an extract treated sample (toxic digest of gliadin pre-incubated with enzyme extract prior to addition of lysosomes), the extent of protection can be determined. A protection index (P.I.) can be calculated from:

$$P . I . ( \% ) = \frac{\begin{matrix}\% reduction toxic sample - \\ \% reduction extract treated sample\end{matrix}}{\% reduction toxic sample} \times 100$$

The results of assay of Fractions 1 to 11 indicated that Fraction 1 had a P.I. of 20%, Fraction 2 had a P.I. of 91% and Fraction 3 had a P.I. of 41%. None of the other fractions had a P.I. of more than 6%. Fraction 2 appears to contain the largest quantity of enzymes showing activity in detoxifying gliadin, representing the most toxic proteins in gluten. Fraction 2 contains enzymes having a molecular weight of between 150 and 200 kDalton, as determined by its elution compared with standards of human γ-globulin (150.0 kDalton), horse haemoglobin (64.5 kDalton) and horse cytochrome C (12.5 kDalton).

### EXAMPLE 3

Further tests in accordance with Example 2 were carried out on Fraction 2 at different pH to determine the optimal pH for enzyme activity. These tests showed the following protection was offered:

pH

| | 4 | 5 | 6 | 7 | 8 | 9 |
|---|---|---|---|---|---|---|
| % Protection | 5.0 | 28 | 51 | 70 | 86 | 80 |
| (P.I.) | | | | | | |

This indicates maximum enzymic activity at about pH 8.4.

### EXAMPLE 4

A small proof in principle trial with four patients was conducted. The trial was a double-blind crossover type in which four biopsy-proven coeliac patients in remission participated. Patients were treated with freeze-dried enzyme extract obtained in accordance with the invention or placebo capsules. Each patient was challenged with 0.6 g of gluten at a time. One capsule was taken immediately before and one immediately after the gluten challenge. At the end of first series of six challenges the patients were crossed over and the trial continued with another six challenges. Patients kept a log book of the time and date of each challenge and recorded the following clinical symptoms: diarrhoea, fatigue/tiredness, flatulence, bloating of the stomach, stomach pain/discomfort, nausea/vomiting, cramps, loss of appetite. In the analysis of the results, all the above symptoms were taken into account. No patient had worse symptoms with the extract than with the placebo. About 88% protection to gluten challenge was offered by the freeze-dried enzyme extract as compared with the placebo offering only 37%.

### EXAMPLE 5

Freeze-dried extract in accordance with the invention was subjected to further fractionation to enhance its activity. The freeze-dried extract (0.5 g) was dissolved in 15 mL of 0.025 mol/L phosphate buffer, pH 7.6, and applied to a column of DEAE Sephadex A-50. (Amersham Pharmacia Biotech Inc.) equilibrated in the same buffer. Fractions were then eluted by application of the starting buffer (to remove unabsorbed proteins) and then with pH 5.0 phosphate buffers up to 0.04 mol/L. Finally, buffers containing sodium chloride (0.15, 0.40 mol/L) were used to elute the active material required. All fractions were monitored by their absorbance in the UV at 280 nm. A large amount of unabsorbed material was obtained indicating that the method could enrich the enzyme activity in the extract.

### EXAMPLE 6

Each fraction from Example 5 was freeze-dried, dissolved in 5 mL de-ionised water and tested for enzyme activity using the rat liver lysosomal assay as described in Example 2. Fractions obtained by use of buffers containing sodium chloride were dialysed prior to freeze-drying. The results of the assay of fractions 1-10, indicated that fraction 7 had a P.I. of 65%, fraction 8 had a P.I. of 17% with most of the other fractions having a P.I. of around 10%. The activity was therefore seen to be concentrated in fraction 7, a fraction eluted with buffer containing 0.15 mol/L sodium chloride. This experiment showed that enrichment of enzyme activity in the extract could be achieved by fractionation on weakly—basic (anion) exchangers and it has been shown that resins such as Amberlite—IRA 68 (Rohm and Haas) can also be used in the same way.

It should be realised that various alterations, modifications and/or addition may be introduced into the methods and formulation previously described without departing from the spirit or ambit of the invention.

1. A method of obtaining an enzyme extract for use in treatment of gluten intolerance comprising:
(a) collecting and chilling animal duodena,
(b) removing intestinal digesta from the duodena,
(c) separating intestinal mucosa from the duodena,
(d) homogenizing the intestinal mucosa with de-ionised water to obtain an aqueous mixture,
(e) clarifying the aqueous mixture,
(f) concentrating the clarified aqueous mixture by ultra filtration to obtain a concentrate, and,
(g) freeze-drying the concentrate to form a freeze-dried enzyme extract.

2. The method of claim 1 wherein the animal duodena are obtained from one or more of cattle, pigs or sheep.

3. The method of claim 2 wherein the animal duodena are obtained from pigs.

4. The method of claim 1, wherein the aqueous mixture is centrifuged for about one hour at about 1,500 g, using one litre buckets in a Beckman laboratory centrifuge.

5. The method of claim 1, wherein the ultrafiltration step is carried out using an ultra filtration membrane of about 100 kDaltons.

6. A method of treating a patient suffering from gluten intolerance, comprising administering one or more peptidase enzymes capable of enzymatic digestion of gluten peptide residues.

7. A method according to claim 6, wherein the one or more peptidase enzymes are capable of enzymatic digestion of residues 11-19 and 75-86 of A-gliadin.

8. A method according to claim 6, wherein the peptidase enzymes are in the form of an enzyme extract derived from animal intestinal mucosa.

9. A method according to claim 8, wherein the animal intestinal mucosa are one or more of bovine, porcine or ovine intestinal mucosa.

10. A method according to claim 9, wherein the animal intestinal mucosa are porcine animal mucosa.

11. A method according to claim 8, wherein the enzyme extract is obtained in accordance with a method of obtaining an enzyme extract for use in treatment of gluten intolerance comprising:
(a) collecting and chilling animal duodena,
(b) removing intestinal digesta from the duodena,
(c) separating intestinal mucosa from the duodena,
(d) homogenizing the intestinal mucosa with de-ionised water to obtain an aqueous mixture,
(e) clarifying the aqueous mixture,
(f) concentrating the clarified aqueous mixture by ultra filtration to obtain a concentrate, and,
(g) freeze-drying the concentrate to form a freeze-dried enzyme extract.

12. A method according to claim 6 wherein the one or more peptidase enzymes each have a molecular weight between 150 and 200 kDalton.

13. A method according to claim 6, wherein the one or more peptidase enzymes each have optimal peptidase activity at a pH from 8 to 9.

14. A method according to claim 6, wherein the amount of peptidase enzyme administered to the patient is sufficient to digest peptide residues from 2.5 g gluten.

15. Use of one or more peptidase enzymes in the manufacture of a medicament for treatment of gluten intolerance, wherein one or more peptidase enzymes are capable of enzymatic digestion of gluten peptide residues.

16. Use of one or more peptidase enzymes in accordance with claim 15, wherein the one or more peptidase enzymes are capable of enzymatic digestion of residues 11-19 and 75-86 of A-gliadin.

17. Use of one or more peptidase enzymes in accordance with claim 15, wherein the peptidase enzymes are in the form of an enzyme extract derived from animal intestinal mucosa.

18. Use of one or more peptidase enzymes according to claim 17, wherein the animal intestinal mucosa are one or more of bovine, porcine or ovine intestinal mucosa.

19. Use of one or more peptidase enzymes in accordance with claim 18, wherein the animal intestinal mucosa are porcine animal mucosa.

20. Use of one or more peptidase enzymes according to claim 17, wherein the enzyme extract is obtained in accordance a method of obtaining an enzyme extract for use in treatment of gluten intolerance comprising:
(a) collecting and chilling animal duodena,
(b) removing intestinal digesta from the duodena,
(c) separating intestinal mucosa from the duodena,
(d) homogenizing the intestinal mucosa with de-ionised water to obtain an aqueous mixture,
(e) clarifying the aqueous mixture,
(f) concentrating the clarified aqueous mixture by ultra filtration to obtain a concentrate, and,
(g) freeze-drying the concentrate to form a freeze-dried enzyme extract.

21. Use of one or more peptidase enzymes in accordance with claim 15, wherein the peptidase enzymes have a molecular weight between 150 and 200 kDalton.

22. Use of one or more peptidase enzymes according to claim 15 wherein the one or more peptidase enzymes have optimal peptidase activity at a pH from 8 to 9.

23. A pharmaceutical formulation for treatment of gluten intolerance, comprising:
one or more peptidase enzymes capable of enzymatic digestion of gluten peptide residues; and
an enteric coating

24. A pharmaceutical formulation in accordance with claim 23, wherein the one or more peptidase enzymes are capable of enzymatic digestion of residues 11-19 and 75-86 of A-gliadin.

25. A pharmaceutical formulation in accordance with claim 23, wherein the one or more peptidase enzymes are in the form of an enzyme extract derived from animal intestinal mucosa.

26. A pharmaceutical formulation in accordance with claim 25, wherein the animal intestinal mucosa are one or more of bovine, porcine or ovine intestinal mucosa.

27. A pharmaceutical formulation in accordance with claim 26, wherein the animal intestinal mucosa are porcine intestinal mucosa.

28. A pharmaceutical formulation in accordance with claim 25, wherein the enzyme extract is obtained in accordance with the method of claim 1.

29. A pharmaceutical formulation in accordance with claim 23, wherein the one or more peptidase enzymes are combined with glidants, fillers, stabilising agents, plasticisers, surfactants, binders and colourants, or other pharmaceutically acceptable excipients prior to being enterically coated.

30. A pharmaceutical formulation in accordance with claim 23, wherein the one or more peptidase enzymes have a molecular weight between 150 and 200 kDalton.

31. A pharmaceutical formation in accordance with claim 23, wherein the one or more peptidase enzymes have optimal peptidase activity at a pH from 8 to 9.

32. A pharmaceutical formulation according to claim 25, comprising: 400 mg of a blend of from 97 to 99.5 weight percent freeze-dried enzyme extract, milled to size 200 mesh, and from 0.5-3 weight percent glidants selected from talc B.P., magnesium stearate B.P. or mixtures thereof, in a hard gelatin capsule, coated with a polymethacrylate-based enteric coating.

33. A pharmaceutical formulation according to claim 25, comprising 60 weight percent freeze-dried enzyme extract, 20 weight percent lactose B.P., 10 weight percent sodium starch glycolate B.P., 8 weight percent polyvinylpyrrolidone B.P., 1 weight percent talc B.P., and 1 weight percent magnesium stearate, which is formed into a tablet and coated with a polymethacrylate-based enteric coating.
